(19) United States
(12) Patent Application Publication
(10) Pub. No.: US 2007/0258206 A1
(43) Pub. Date: Nov. 8, 2007

(54) Heat dissipating base for laptops

(76) Inventor: Tai-Chi Huang, Kaoshyong City (TW)

Correspondence Address: RABIN & Berdo, PC, 1101 14TH STREET, NW, SUITE 500, WASHINGTON, DC, 20005, US

(21) Appl. No.: 11/415,155

(22) Filed: May 2, 2006

(51) Int. Cl. G06F 1/20

(52) U.S. Cl. 361/687

(57) ABSTRACT

A heat dissipating base for laptops includes a casing member, inside which at least a fan is located, and an air duct which allows the fan to expel the air to the outside of the casing member. A cover member with an inclined top plate is joined to the casing member and an opening is made on the cover member to allow the fan to draw air into the casing member. The top face plate is curved inward and forms a gap between the top face plate and the bottom of the laptop resting on the heat dissipating base. The top face plate has multiple ventilation holes, so the cool air is sucked through the holes to efficiently cool down the temperature of the laptop.

### BACKGROUND OF THE INVENTION

1. Field of the Invention

The present invention generally relates to heat dissipating bases for laptops, and more particularly to a heat dissipating base that sucks and removes the heat generated by a laptop.

2. The Prior Arts

Laptops have been continuously upgraded for more function and higher computing speed. In the mean time, the heat produced by the laptops is also dramatically increased. The high temperature has to be reduced; otherwise components of the laptop such as CPU, memory, adaptor cards, etc. would be over heated and failed. The operational lifespan of the laptop would also be affected if the laptop is continuously operated under such high temperature. As a result, the auxiliary devices for heat dissipation such as the heat dissipating bases are therefore greatly demanded by laptop users.

Most of the conventional heats dissipating bases for laptops have a flat body structure upon which the laptop is placed. The surface of the flat body structure for supporting the laptop is usually made from aluminum, which has high thermal conductivity, and therefore it is able to dissipate the heat produced by the laptop quickly. Nevertheless, the conventional heat dissipating base has a number of disadvantages: (a) the flat body structure can be deformed easily by the weight of the laptop and, once it is deformed, its aluminum surface has less contact area with the laptop and its heat dissipating efficiency is reduced; (b) aluminum is expensive and so it increases the production cost; (c) aluminum is heavy and so the heat dissipating base is less convenient to carry; and (d) the conventional heat dissipating base usually has air exhausts configured at the bottom, which is susceptible to the recirculation of heat and therefore reduces the heat dissipating effect.

### SUMMARY OF THE INVENTION

Accordingly, a heat dissipating base for laptop is provided herein. The heat dissipating base comprises a hollow casing member, a cover member mounted on the base, and a top face plate in turn mounted on the cover member. The casing member has at least a fan housing within which a fan is installed, and an air duct allowing the fan to expel hot air to outside of the casing member. The cover member has at least an opening which is located correspondingly to the fan housing and allows the fan to draw air into the casing member. The top face plate has multiple ventilation holes which are located above the opening of the cover member. The cover member and the top face plate are configured such that the top face plate is curved inward, leaving a gap between the bottom of the resting laptop and the top face plate itself. The heat produced by the laptop, and cool air are together sucked into casing member through the gap, the ventilation holes of the top face plate, and the opening of the cover member, and then they are expelled through the air duct on the lateral sides of the casing member, causing a well air circulation system and an enhanced heat dissipating efficiency.

The foregoing and other objects, features, aspects and advantages of the present invention can be understood better by reading carefully the detailed description provided herein below with appropriate reference to the accompanying drawings.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view showing the heat dissipating base according to an embodiment of the present invention;

FIG. 2 is an exploded view showing the heat dissipating base of FIG. 1;

FIG. 3 is a top view of the heat dissipating base of FIG. 1;

FIG. 4 is a perspective showing a laptop placed on the heat dissipating base of FIG. 1, and

FIG. 5 is a side view showing a laptop placed on the heat dissipating base of FIG. 1.

### DETAILED DESCRIPTION OF THE PREFERRED EMBODIMENT

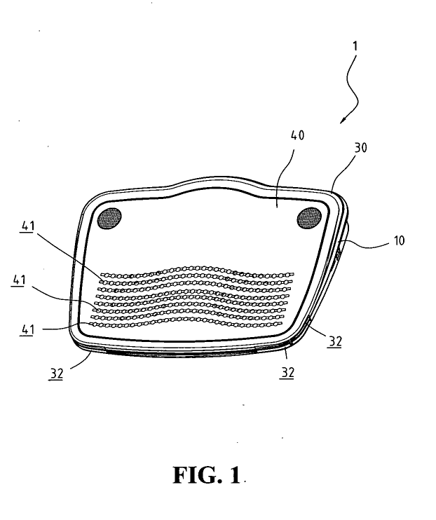

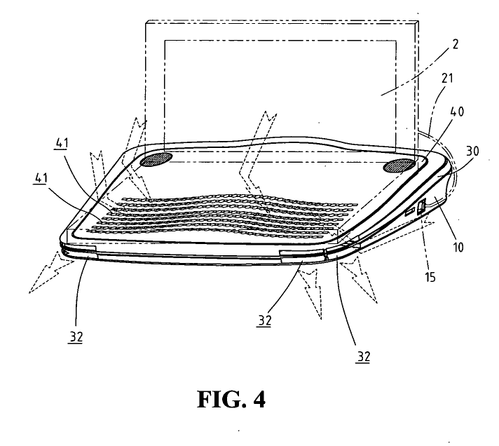

With reference to the drawings and in particular to FIGS. 1 to 5, a heat dissipating base 1, according to an embodiment of the present invention, comprises a hollow casing member 10 whose top surface is slant from the back towards the front. The casing member 10 has two fan housings 11 at the bottom to accommodate two fans 20, which are the blower fans in accordance to the present embodiment. Two air ducts 12 are provided respectively between the fan housings 11 and in the appropriate locations on the side wall of the casing member 10, and the width of the air ducts 12 gradually increases from the fan housings 11 towards the side wall of the casing member 10.

A cover member 30 is provided on top of the casing member 10. The cover member 30 has two openings 31 on top which exposed the fan housings 11 of the casing member 10. When the cover member 30 is mounted onto the casing member 10, outlets 32 are formed on the side wall of the casing member 10, so the hot air inside the casing member 10 can be expelled by the fans 20 through the air ducts 12.

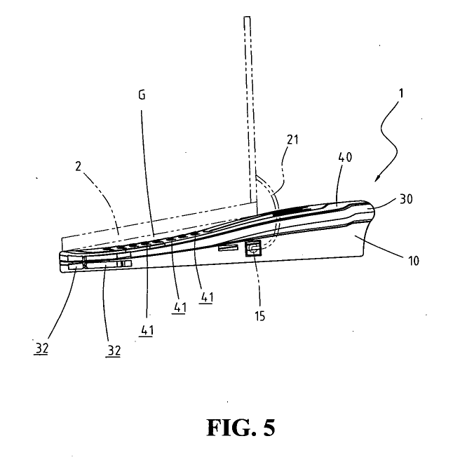

A top face plate 40 is mounted onto the top surface of the cover member 30. The cover member 30 and the top face plate 40 are designed to slightly curve inward, as shown in FIG. 5. When the laptop 2 is placed on the top face plate 40, there is a gap “G” between the top face plate 40 and the bottom of the laptop 2. The top face plate 40 has multiple ventilation holes 41 above the top openings 31 of the cover member 30.

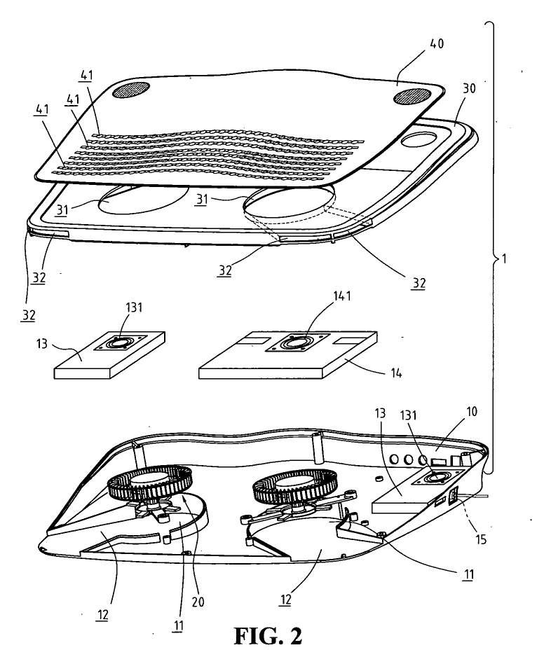

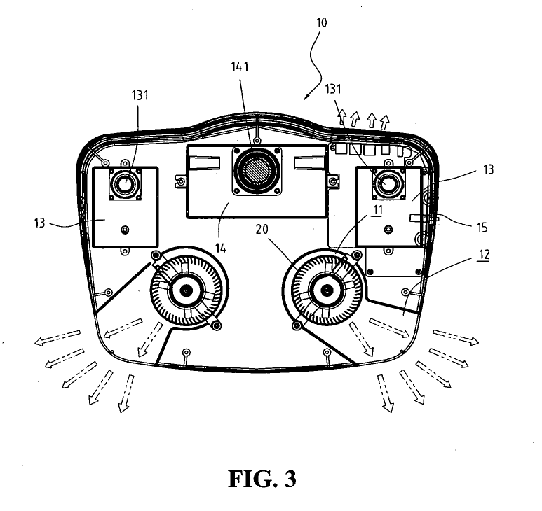

The present invention can be functioned further as a speaker system. As shown in FIGS. 2 and 3, at least a full-range audio output device 13 and at least a bass output device 14 are provided inside the casing member 10. The audio output device 13 includes at least a speaker 131 and a connector 15. The bass output device 14 includes at least a subwoofer 141 and is connected to the audio output device 13 to receive audio signal from the connector 15. The audio output port of the laptop 2 can be connected to the connector 15 via a signal cable 21, so the audio signals produced by the laptop 2 can be presented by the audio and bass output devices 13 and 14. In an alternative embodiment, a microphone device can be incorporated in the casing member 10 and connected to the audio input or microphone input port of the laptop 2. In this way, the present invention can function as, in addition to a heat dissipating base, an audio input and output device.

When the fans 20 are operated, they sucks air into the casing member 10 through the gap “G” and the ventilation holes 41 and expels the air out through the air ducts 12 and the outlets 32. As such, a low-pressure zone is formed inside the gap “G” where both the hot air from the heat of the laptop 2 and cool air are drawn through the casing member 10, and it creates enhanced air circulation to cool the laptop 2 down.

In addition, as the laptop 2 is positioned on the slant top plate 40, the weight of the laptop 2 is better supported by the casing member 10. In other words, the casing member 10, the cover member 30, and/or the top plate 40 can be made by lighter and cheaper plastic material instead of aluminum or other costly metal, thereby achieving better mobility.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A heat dissipating base for a laptop comprising the following:
a) a hollow casing member has at least a fan housing within which a fan is installed, and an air duct connects the fan housing to the outside of the casing member;
b) a cover member positioned on top of the casing member has at least an opening located correspondingly to the fan housing; and
c) a top face plate positioned on top of the cover member has multiple ventilation holes located above the opening of the cover member, upon where the laptop is rested.

2. The heat dissipating base as claimed in claim 1, wherein the top surface of the casing member is slant from the back towards the front of the casing member.

3. The heat dissipating base as claimed in claim 1, wherein the width of the air duct gradually increases from the fan housing towards the side wall of the casing member.

4. The heat dissipating base as claimed in claim 1, wherein the fan is a blower fan.

5. The heat dissipating base as claimed in claim 1, wherein the top face plate is curved inward to create a gap between the top face plate and the bottom of the laptop.

6. The heat dissipating base as claimed in claim 1, wherein the casing member is made by plastic.

7. The heat dissipating base as claimed in claim 1, wherein the cover member is made by plastic.

8. The heat dissipating base as claimed in claim 1, wherein the top plate is made by plastic.

9. The heat dissipating base as claimed in claim 1, further comprising an additional audio presentation device and a microphone device housed inside the casing member.

10. The heat dissipating base as claimed in claim 9, wherein the audio presentation device comprises at least a full-range audio output device and at least a bass output device, the full-range audio output device has at least a speaker and a connector for connecting to an external audio source via appropriate audio cables, and the bass output device has a subwoofer and is connected to the audio output device to receive the audio signal from the connector.
